(19) United States
(12) Patent Application Publication
(10) Pub. No.: US 2004/0198379 A1
(43) Pub. Date: Oct. 7, 2004

(54) Method for authorizing location services

(76) Inventors: Stephen D. Magee, Scottsdale, AZ (US); Robert A. Patzer, Lake Zurich, IL (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/229,965

(22) Filed: Aug. 28, 2002

(51) Int. Cl. H04M 3/00; H04Q 7/20

(52) U.S. Cl. 455/456.1; 455/418

(57) ABSTRACT

A presence server (70) receives a location from a location server (60) of a mobile device (10). If the mobile device has location based communication services provisioned for it (112), the presence server retrieves a current list of businesses authorized to send notifications to the mobile device (162). If the business is at the location of the mobile device (164) and if the mobile device allows notifications from that business (168), the presence server sends the notifications to the mobile device (170).

### BACKGROUND OF THE INVENTION

The present invention pertains to mobile telecommunication systems and more particularly to a method for delivery of telecommunication services to mobile subscribers based upon the location of the mobile subscriber.

Older mobile telecommunication systems did not locate the user per se. These systems established which of a number of antennas was best suited to handle a subscriber's communication. When the subscriber moved from a first cell to a second cell, another antenna would be best suited to handle the communication with the subscriber. So the first cell and the second cell would hand-off the communication from the first cell to the second cell.

In more modern mobile telecommunication systems a subscriber's geographic location was determined by his hand set solely or in conjunction with the mobile telecommunication system. There are a number of geographical location services that can be provided to a subscriber. One such service is emergency assistance services. If the location of a subscriber is known a call for medical or police help may be dispatched without lengthy conversation with the subscriber.

Current 2.5G and 3G mobile cellular systems are installing equipment to monitor the subscriber's geographical location. In addition, location based services have been expanded to include, for example, requested advertising and information when entering a shopping mall. Upon entering the mall the information is immediately sent to the subscriber's mobile terminal or device.

The problem associated with this type of location based service is how to control the type and amount of information sent to the mobile device. Many people may not want such information at all. Others may require only certain types of information, for example, clothing stores having a sale. This results in an inferior user experience. As a result, many subscribers may opt to turn off all location based service messaging in order to avoid unwanted solicitations. Therefore, it would be highly desirable to have a method for providing location based messaging services which provides greater control for the subscriber.

### BRIEF DESCRIPTION OF THE DRAWINGS

FIG. 1 is a block diagram of a public LAN mobile network in accordance with the present invention.

FIG. 2 is a flow chart depicting an operation of a mobile device in accordance with the present invention.

FIGS. 3, 4 and 5 are block flow diagrams of an operational flow of a network in accordance with the present invention.

### DESCRIPTION OF THE PREFERRED EMBODIMENT OF THE INVENTION

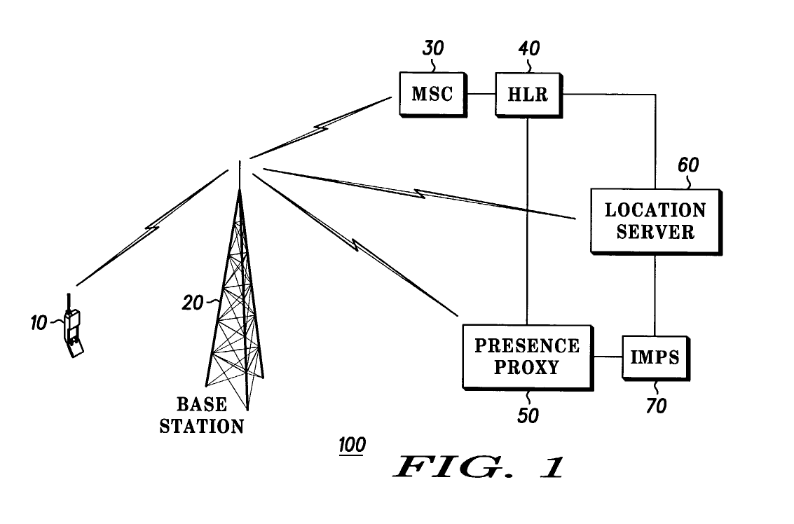

Referring to FIG. 1, a block diagram of a home network 100 (Public LAN mobile network (PLMN)) is shown. The network includes an instant messaging and presence server (IMPS) or simply presence server 70. The home network 100 includes among other things, the IMPS or presence server 70. The presence server which is the heart of the method for providing authorization for location based services, is coupled to location server 60 and to presence proxy 50. Presence server 70 manages a contact list for each subscriber 10. Presence server 70 also synchronizes the contact list with the subscriber as represented by mobile station or mobile device 10. Further, presence server 70 manages the presence state for mobile station or device 10 and supports searches for new contacts in its database.

Mobile station or mobile device 10 may include a mobile telephone, paging device, mobile computer or other device capable of mobile telecommunications.

Mobile station 10 is wirelessly coupled to base station 20. Base station 20 is typically part of a radio access network (RAN). Base station 20 is coupled to mobile switching center (MSC) 30. Mobile switching center 30 is in turn coupled to home location register (HLR) 40. MSC 30 and HLR 40 form a circuit switched portion of home network 100.

Base station 20 is also coupled to location server 60. Location server 60 detects the location of mobile station 10 and triggers the location based messaging services. Location server 60 is coupled to HLR 40.

Base station 20 is also coupled to presence proxy 50. Presence proxy 50 provides interface between presence server (IMPS) 70 and mobile station 10. Presence server 50 is also coupled to home location register 40.

Instant messaging and presence server (IMPS) 70 is coupled to location server 60 and to presence proxy 50. Presence proxy 50, location server 60 and presence server 70 comprise the packet switched portion of the home network 100. When location server 60 detects the mobile station 10 within a particular geographic area for which presence services are available, location server 60 sends a signal which triggers presence server 70. Presence server 70 evaluates the particular subscriber 10 against the stored contact list. If the contact list and its associated database indicate notification of presence services are permissible, presence server 70 sends the information via presence proxy 50 to mobile station 10 via base station 20. Location server 60 detects particular conditions for transmitting the triggering signal to presence server 70. For example, if mobile station 10 has entered a shopping mall, school or sports stadium, for example.

Typically, the mobile station 10 determines its geographic location and updates location server 60 with its location.

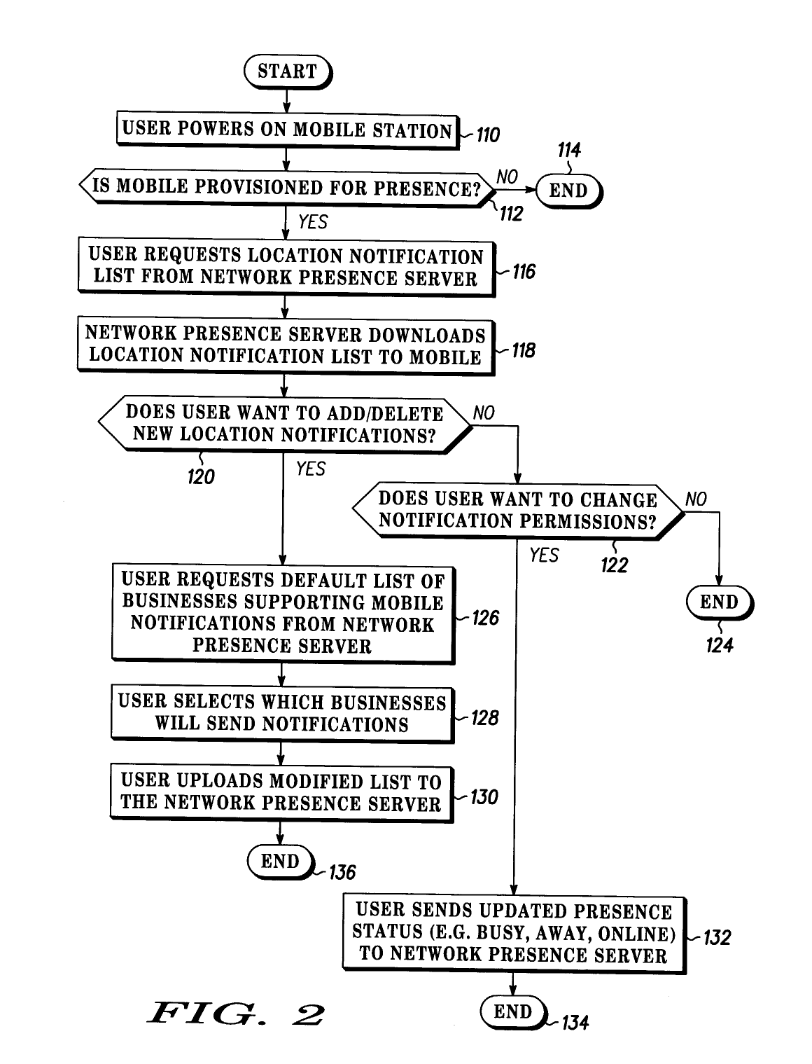

Referring to FIG. 2, a flow chart of the operation of the mobile station or device 10 is shown. The process is started and block 110 is entered. The user or subscriber powers on the mobile station, block 110. Next, block 112 is entered which the mobile station determines whether it is provisioned for the presence feature. If the mobile station 10 is not equipped or provisioned with the presence feature, block 112 transfers control to block 114 which ends the process.

If the mobile device is equipped with the presence feature, block 112 transfers control to block 116 via the yes path. In block 116 the subscriber requests location notification lists from the presence server 70. Next, in block 118 the presence server 70 downloads or transmits the notification list associated with that geographic location to the mobile station 10.

Next, the user or subscriber of the mobile station 10 determines whether to add or delete new location notifications to the contact list stored by the presence server 70. If the user does not wish to add or delete new location notifications, block 20 transfers control to block 122 via the no path. In block 122 the mobile device determines whether the user wants to change the notification permissions. If the user wishes to change the permissions for controlling which notifications are transmitted to the mobile unit, block 122 transfers control to block 132 via the yes path. If the subscribe or user does not wish to change the notification permissions, block 122 transfers control to end the process at block 124 via the no path.

If the user wants to change the notification permissions, block 122 transfers control to block 132 via the yes path. Block 132, the mobile device then sends the user selected presence status to the presence server 70. Sample statuses are busy, away, online, etc. The process is then ended, block 134.

If the subscriber user did wish to add or delete location notifications, block 120 transfers control to block 126 via the yes path. Next, the subscriber requests a default list of the businesses or institutions supporting location based mobile notifications from presence server 70. The subscriber then selects the businesses which will transmit notifications, block 128. Lastly, the subscriber uploads the modified list of businesses or institutions to the presence server 70, block 130. Then the process is ended, block 136.

As can be seen from the above explanation, this method allows the subscriber or user to control which location based messages the subscriber will receive at a particular location. In addition, the subscriber may choose to block all messaging. For example, the subscriber may wish to have information on sporting goods when entering the mall and exclude information from clothing stores. Alternately, the subscriber may wish to receive no messages whatsoever based upon his presence in a mall or a sporting stadium. Also, the user has control as to initiating step 116. The user may decide to execute step 116 immediately on powering up the mobile or may execute step 116 at any time while the mobile is powered on.

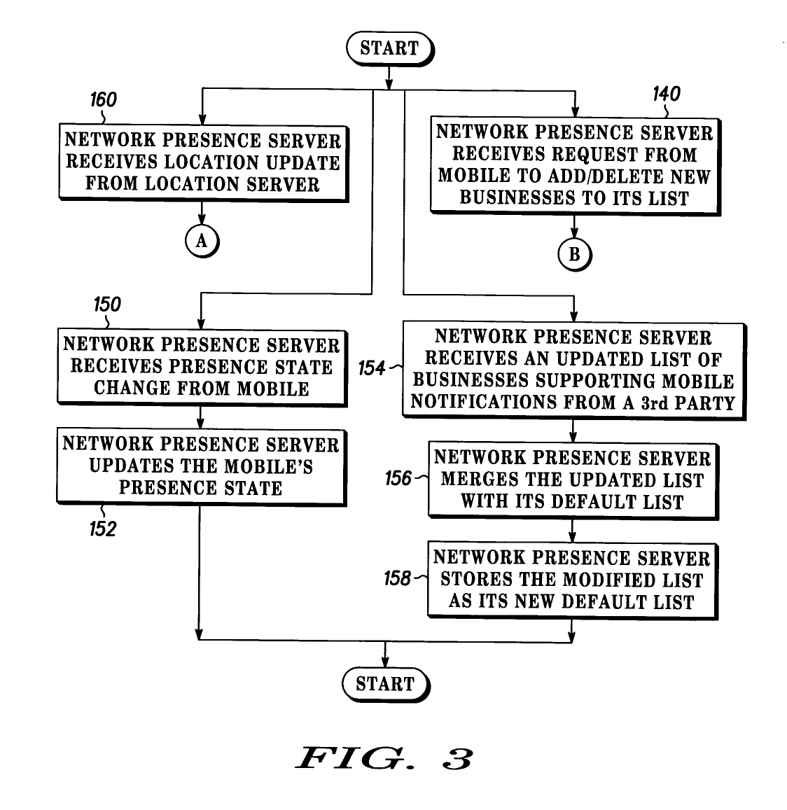

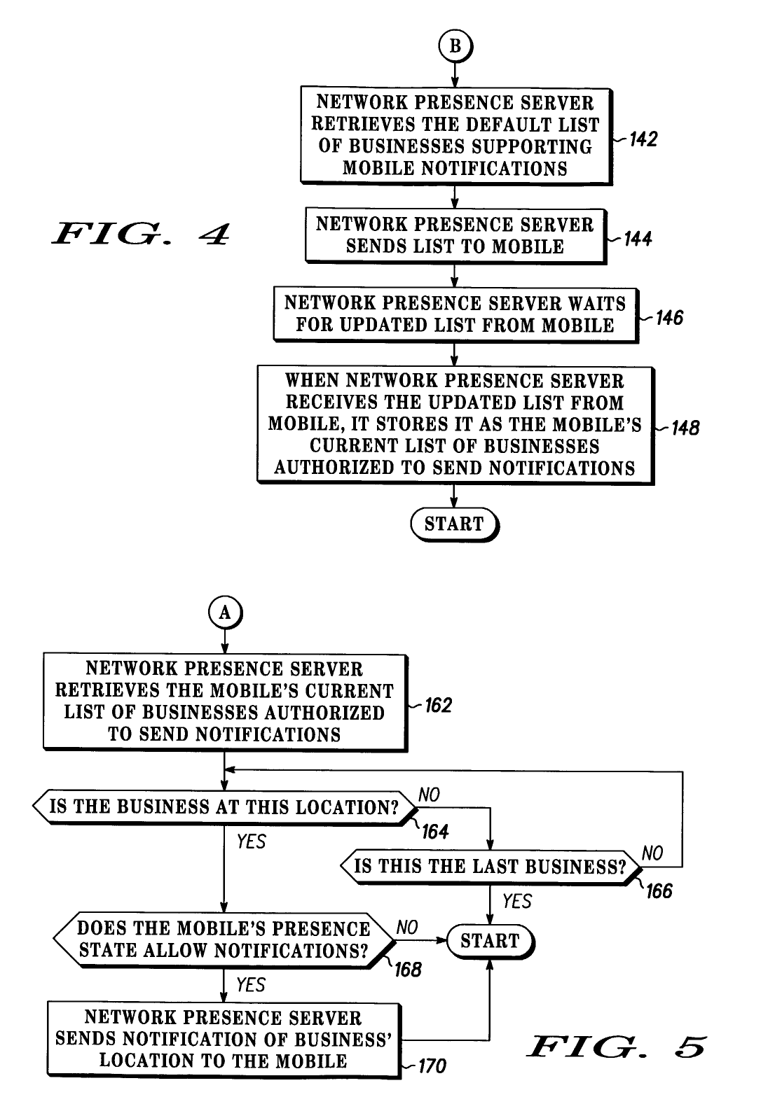

Referring to FIGS. 3, 4 and 5, an operational flow diagram of the presence server 70 for the home network is shown.

In a first network operation, presence server 70 receives a presence state change from mobile station 10, block 150. Presence server 70 updates the mobile station's presence state in its associated contact list, block 152. Block 152 then transfers control to the start operation awaiting the next instruction from mobile station 10.

A second operation of the presence server 70 of the network is depicted by block 154. In block 154 the presence server receives an updated list of businesses or institutions supporting mobile notifications from a third party. Next, presence server 70 merges the updated list with a default list for the particular location, block 156. Lastly, for the second operation, presence server 70 stores the modified list as a new default list within the presence server database, block 158. Then block 158 transfers control to the start, awaiting the next network operation selected by the mobile station 10.

In a third operation of the presence server 70, presence server receives a request from the mobile station 10 to add or delete new businesses or institutions to its contact list, block 140. Next, the presence server retrieves the default list of businesses and institutions supporting mobile notifications, block 142. Presence server 70 then transmits this list to the mobile station 10 through the home network 100, block 144. Then presence server 70 waits for the updated list from the mobile station 10, block 146. Lastly, when the presence server 70 receives the updated list from mobile station 10, the presence server stores the list as the mobile device's current list of businesses and institutions authorized to send notifications, block 148. Block 148 then transfers control to the start to await the next request or operation of the mobile station.

In another operation of the presence server, presence server 70 receives a location update from location server 60, block 160. Next, presence server 70 retrieves the mobile station's current list of businesses or institutions authorized to send notifications, block 162. Next, the presence server determines whether the business or institution is at the location, block 164. If the business is not at the location, block 164 transfers control to block 166 via the no path. Block 166 determines whether this is the last business of the list. If this is the last business, block 166 transfers control back to block 164 via the no path. If this is the last business of the list, block 166 transfers control to the start to await the next request of the mobile station.

If the business is at the location, block 164 transfers control to block 168 via the yes path. Block 168 determines whether the mobile station's presence state permits notifications by businesses or institutions. If not, block 168 transfers control to the start process to wait for the next operation requested by the mobile station. If the mobile station's presence state allows notifications, block 168 transfers control to block 170 via the yes path. In block 170, presence server 70 sends notification of the businesses' location and other pertinent information to the mobile station. Block 170 then transfers control to start to await the next action by the mobile station.

The methodology shown above provides for instant messaging and presence service for authorizing an/or restricting delivery of location based message services to a mobile subscriber. Further, the mobile subscriber is provided with the capability to directly modify his service profiles and add restrictions or remove restrictions without interfacing with a network operator. The mobile subscriber or user may dynamically update the services available to the user. And lastly, the above methodology provides for filtering location service messaging to avoid unwanted solicitations.

Although the preferred embodiment of the invention has been illustrated, and that form described in detail, it will be readily apparent to those skilled in the art that various modifications may be made therein without departing from the spirit of the present invention or from the scope of the appended claims.

1. A method for authorizing location based communication services between a mobile telecommunication network and a mobile device, the method comprising the steps of:
determining a location of the mobile device;
determining by the mobile telecommunication network whether the mobile device allows a notification by entities in a proximity of the location; and
receiving by the mobile device a list of messages from the entities in the proximity of the location.

2. The method as claimed in claim 1, wherein there is further included the steps of:
determining by the mobile device the location of the mobile device; and
sending the location of the mobile device to a location server.

3. The method as claimed in claim 2, wherein there is further included the steps of:
receiving by a presence server the location of the mobile device; and
responsive to the step of receiving, obtaining a current list of entities authorized to send the notification to the mobile device.

4. The method as claimed in claim 3, wherein there is further included determining by the presence server of the mobile telecommunication network whether each entity of the current list of entities is at the location of the mobile device.

5. The method as claimed in claim 4, wherein the step of determining by the mobile telecommunication network includes the step of determining by the presence server whether a presence state of the mobile device allows the notification for each of the entities on the current list.

6. The method as claimed in claim 5, wherein there is further included the step of sending by the presence server the notification of entities at the location being allowed to send notification to the mobile device.

7. The method as claimed in claim 1, wherein there is further included the step of determining by the mobile device whether the mobile device is provisioned for a presence function.

8. The method as claimed in claim 1, wherein there is further included a step of requesting by the mobile device a list of entities at the location and allowed to send a notification message.

9. The method as claimed in claim 1, wherein there is further included the steps of:
determining by the mobile device whether a permission of the notification is to change; and
updating by the mobile device a presence status with a presence server.

10. The method as claimed in claim 1, wherein there is further included the step of determining by the mobile device whether to update the notification of the location.

11. The method as claimed in claim 10, wherein there is further included the step of requesting by the mobile device a default list of the entities providing the notification.

12. The method as claimed in claim 11, wherein there is further included the steps of:
receiving by the mobile device the default list from a presence server; and
selecting by the mobile device at least one entity to give permission to send the notification.

13. The method as claimed in claim 12, wherein there is further included a step of sending by the mobile device a modified list of entities with permission for a notification to the presence server.

14. The method as claimed in claim 1, wherein there is further included the step of receiving by a presence server of the mobile telecommunication network a request to update the entities of a list corresponding to the mobile device.

15. The method as claimed in claim 14, wherein there is further included the steps of:
obtaining by the presence server a default list of entities; and
sending the default list to the mobile device.

16. The method as claimed in claim 15, wherein there is further included the steps of:
updating by the mobile device the default list to produce a new list of entities with permission for location based services; and
storing by the presence server the new list as a current list of authorized entities for the mobile device.

17. The method as claimed in claim 1, wherein there is further included the step of receiving by a presence server of the mobile telecommunication network a list of entities for supporting the notification.

18. The method as claimed in claim 17, wherein there is further included the steps of:
merging the list of entities with a default list of entities to provide a new default list of entities; and
storing the new default list of entities by the presence server.

19. A method for authorizing location based communication services by a mobile device, the method comprising the steps:
determining a location of a mobile device;
receiving by the mobile device a list of entities in a proximity of the location; and
selecting by the mobile device at least one entity on the list for allowing a message to be received by the mobile device.

20. A method for authorizing location based communication services by a mobile telecommunication network, the method comprising the steps of:
receiving by a presence server of the mobile telecommunication network a location of a mobile device;
obtaining by the presence server a list of entities authorized to send a notification to the location of the mobile device; and
sending by the presence server the notification of each entity which is authorized to the mobile device.
